(19) United States
(12) Patent Application Publication
(10) Pub. No.: US 2016/0144213 A1
(43) Pub. Date: May 26, 2016

(54) Automatic Fire Suppressing System

(71) Applicant: David Titus, Brooklyn, NY (US)

(72) Inventor: David Titus, Brooklyn, NY (US)

(21) Appl. No.: 14/550,934

(22) Filed: Nov. 22, 2014

(51) Int. Cl. A62C 35/62; A62C 35/68; A62C 37/44

(52) U.S. Cl. CPC A62C 35/62; A62C 37/44; A62C 35/68

(57) ABSTRACT

Disclosed is a fire suppressing system that can be used in conjunction with one or more containers having fire suppressing material therein. The fire suppressing system includes an elongated hose having a first end removably connected to one or more containers, and further including a control valve thereon. The elongated hose comprises an inner layer and a braided outer layer that is heat resistant. The second end of the elongated hose is connected to a sprinkler bar. The sprinkler bar includes one or more sprinklers and one or more heat sensors. The sprinkler bar can be secured to a ceiling, wall, or other support surface by means of any suitable fastener. Once the heat sensors detect an elevated temperature associated with fire, the control valve opens so that fire suppressing material therein can flow through the elongated hose and can be dispersed by the sprinklers.

### CROSS REFERENCE TO RELATED APPLICATION

This application claims the benefit of U.S. Provisional Application No. 61/842,483 filed on Jul. 3, 2013, entitled “Flame Off.” The above identified patent application is herein incorporated by reference in its entirety to provide continuity of disclosure.

### BACKGROUND OF THE INVENTION

1. Field of the Invention

The present invention relates to a fire suppressing system. More specifically, the present invention provides a fire suppressing system for use with one or more containers having fire suppressing material therein, wherein the present invention includes heat sensors for detecting elevated temperatures associated with a fire and a control valve on said one or more containers adapted to open once the heat sensors detect a fire, wherein opening the control valve allows the fire suppressing material within the containers to flow through an elongated hose and out from one or more sprinklers connected thereto.

Homes and other buildings are often damaged or destroyed by fires. Further, fires can damage personal property and can even result in loss of life. Fires are often started by old and damaged electrical systems within a home that can overheat or create sparks that ignite dry and flammable materials. Similarly, overloaded outlets may create sparks which can also start a fire. As a result, precautions are often taken to reduce the likelihood of a fire, or to provide convenient means of extinguishing a fire. However, conventional fire extinguishing means require a user to extinguish a fire by hand, using a fire extinguisher, buckets of water, or heavy blankets.

Many homes are not equipped with sprinkler systems or other automatic fire suppressing systems. As a result, if a fire breaks out within a person's home, the person must manually try to fight the fire using buckets of water or heavy blankets in an attempt to extinguish the fire. However, it is dangerous for a user to try to put out a fire by himself or herself, and the stress of the situation may compromise the user's ability to act quickly and effectively in suppressing the fire. Similarly, the use of a fire extinguisher requires the user to locate a fire extinguisher, stand close to the fire, and direct the nozzle of the extinguisher towards the fire. Thus, a system that automatically responds to a fire and that can be easily installed is desired.

The present invention provides a fire suppressing system for use with a container filled with fire suppressing material. The present invention comprises an elongated hose having a first end removably securable to one or more containers. A control valve is positioned thereon that seals the container or allows the contents of the container to flow therefrom. The second end of the elongated hose is secured to a sprinkler bar. The sprinkler bar includes one or more sprinklers and one or more heat sensors. Once a heat sensor detects a particular temperature associated with a fire, a signal is transmitted to the control valve causing the control valve to open, allowing fire suppressing material held within the containers to flow through the elongated hose, and out from the sprinklers on the sprinkler bar. Thus, the present invention provides a means for automatically responding to a fire within a home.

2. Description of the Prior Art

Devices have been disclosed in the prior art that relate to fire suppressing systems. These include devices that have been patented and published in patent application publications. These devices generally relate to fire suppressing systems for dispensing a fire suppressing material. The following is a list of devices deemed most relevant to the present disclosure, which are herein described for the purposes of highlighting and differentiating the unique aspects of the present invention, and further highlighting the drawbacks existing in the prior art.

One such patent, U.S. Pat. No. 8,230,939 to Reynolds discloses a fire protection system adapted for use with kitchen stoves. The system is thermally activated and is adapted to release a fire suppressing material and cut the electrical power to the stove. The system includes a reservoir containing fire suppressing material and a hose having a thermally activated nozzle such that the fire suppressing material is released when extreme heat is detected. Thus, Reynolds discloses a fire protection system for use with a stove, and not a fire suppressing system for use in a room of a home and that includes a sprinkler bar with one or more sprinklers and heat sensors thereon.

U.S. Pat. No. 6,029,751 to Ford et al. discloses an automatic fire suppressing system. The system comprises a tank having a fire suppressing material and having a temperature activated valve adapted to dispense the material when the valve is opened. The valve closes automatically once the high temperature condition no longer exists. While Ford et al. discloses a fire suppressing system, Ford et al. fails to disclose a fire suppressing system that includes a sprinkler bar having one or more sprinklers and heat sensors thereon.

U.S. Pat. No. 7,878,258 to Lindstrom et al. discloses a fire suppressing system comprising a sprayer system through which a liquid fire suppressing material is dispensed. The device includes at least one sensor for detecting a fire, a fire extinguishing container with liquid medium therein, a pressurizing system to pressurize the liquid, and one or more nozzles for dispensing the liquid medium. Thus, Lindstrom et al. fails to disclose a fire suppressing system comprising an elongated hose for connection to a container filled with fire suppressing material, wherein the elongated hose is further connected to a sprinkler bar with one or more sprinklers and heat sensors thereon.

U.S. Pat. No. 8,403,070 to Lowe discloses a fire protection system for a building comprising one or more fire-resistant covers that can be used to cover the building to prevent a fire from spreading to the building. Further, sprinklers are adapted to dispense water on the inside of the covers and the exterior of the building. Thus, Lowe relates to a system for preventing a fire from spreading to a building, and does not disclose a fire suppressing system for extinguishing a fire within a home.

U.S. Pat. No. 6,691,790 to MacDonald, III et al. discloses a fire suppressing system. The system includes a manifold for supplying fire suppressing material to wall-mounted sprinklers through flexible conduits. Further, a method is provided for installing the system in new and existing buildings. MacDonald, III et al. discloses a fire suppressing system to be installed within the walls of a home or building, and fails to disclose a fire suppressing system comprising a sprinkler bar with one or more sprinklers and one or more heat sensors.

Finally, U.S. Pat. No. 5,868,205 to Cunningham et al. discloses an automatic fire extinguishing device. The device includes a container in which a fire extinguishing agent can be stored. The container includes an aperture such that the container is in fluid communication with a vessel. A thermally activated closure is coupled to the container for sealing the aperture. Thus, Cunningham fails to disclose a fire suppressing system having an elongated hose connected to a sprinkler bar having one or more sprinklers and one or more heat sensors thereon.

These prior art devices have several known drawbacks. Several devices in the prior art relate to fire suppressing systems for stoves or ovens. Such devices are limited to use with ovens, and are not suited for broader applications, such as suppressing a fire in other areas of a home. The devices in the prior art further fail to provide a sprinkler bar having one or more sprinklers and heat sensors thereon. The sprinkler bar allows for easy installation of the fire suppressing system in various locations.

In light of the devices disclosed in the prior art, it is submitted that the present invention substantially diverges in design elements from the prior art and consequently it is clear that there is a need in the art for an improvement to existing fire suppressing systems. In this regard the instant invention substantially fulfills these needs.

### SUMMARY OF THE INVENTION

In view of the foregoing disadvantages inherent in the known types of fire suppressing systems now present in the prior art, the present invention provides a new fire suppressing system wherein the same can be utilized for providing convenience for the user when automatically extinguishing a fire within a home.

It is therefore an object of the present invention to provide a new and improved fire suppressing system that has all of the advantages of the prior art and none of the disadvantages.

It is another object of the present invention to provide a fire suppressing system adapted for use with a container filled with fire suppressing material.

Another object of the present invention is to provide a fire suppressing system comprising an elongated hose and a sprinkler bar having one or more sprinklers for dispensing a fire suppressing material.

Yet another object of the present invention is to provide a fire suppressing system comprising heat sensors for detecting a fire and automatically dispensing a fire suppressing material.

Another object of the present invention is to provide a fire suppressing system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the fire suppressing system of the present invention.

FIG. 2 shows a cross-sectional view of the elongated hose of the present invention.

FIG. 3 shows a view of an embodiment of the present invention as installed within a room.

### DETAILED DESCRIPTION OF THE INVENTION

Reference is made herein to the attached drawings. Like reference numerals are used throughout the drawings to depict like or similar elements of the fire suppressing system. For the purposes of presenting a brief and clear description of the present invention, the preferred embodiment will be discussed as used for automatically extinguishing a fire in a room of a home. The figures are intended for representative purposes only and should not be considered to be limiting in any respect.

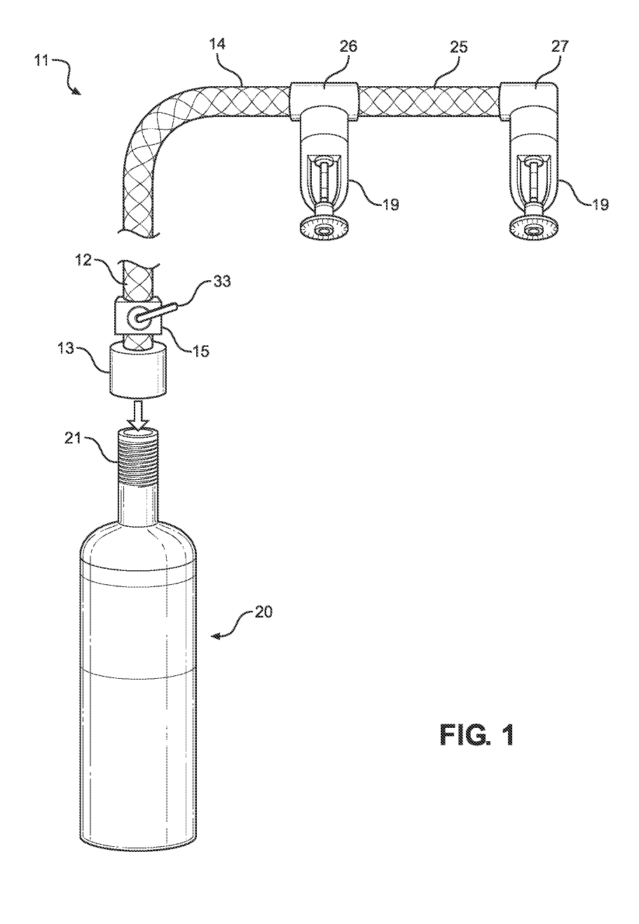

Referring now to FIG. 1, there is shown a perspective view of an embodiment of the fire suppressing system of the present invention. The present invention relates to a fire suppressing system adapted for use with one or more containers 20 filled with fire suppressing material. The container 20 may have any of a variety of shapes, and is preferably cylindrical. The container 20 is filled with a fire suppressing material stored under pressure. Preferably, for purposes of the present invention, the fire suppressing material is a liquid, such as water, or water with a chemical additive. The container 20 further includes an opening 21 thereon such that the fire suppressing material can be released from the interior thereof. The container 20 includes threading about the opening 21 thereof.

The present invention further comprises an elongated hose 12 having a first end 13 and a second end 14. The elongated hose 12 is tubular such that it has a hollow interior and the elongated hose is open at both the first end 13 and the second end 14 thereof. The first end 13 is adapted to be removably secured to the opening of a container 20 filled with fire suppressing material. In alternate embodiments of the present invention, the first end 13 may comprise a plurality of terminations that can be removably secured to multiple containers 20 so as to provide additional fire suppressing material for extinguishing a fire. Preferably, the first end 13 of the elongated hose, or each termination of the first end 13, comprises threading on the interior thereof that can be engaged with the threading on the exterior of the opening 21 of a container 20. Thus, the elongated hose 12 and container 20 are placed in fluid communication with one another.

The first end 13 of the elongated hose 12 further includes a control valve 15 thereon that serves to open or close the container 20 so that fire suppressing material can flow from the container 20 into the elongated hose 12. The valve 15 may be manually opened and closed by a user via a lever. Alternatively, the control valve 15 may be adapted to receive a signal from a heat sensor of the present invention. Once a heat sensor detects a temperature at or above a predetermined level, the heat sensor sends the control valve a signal via a wired or wireless connection therewith, causing the control valve 15 to open. In this way, the present invention automatically responds to a fire by dispersing fire suppressing material.

In the illustrated embodiment, the second end 14 of the elongated hose 12 is in fluid communication with one or more sprinklers 19. The second end 14 can be connected to a T-joint 26 on which a sprinkler 19 is positioned. Fire suppressing material can thus flow to through the T-joint 26 to the sprinkler 19 thereon and through an additional length of tubing 25 and to another joint 27 on which a sprinkler 19 is positioned. Thus, joints 26, 27 can be arranged in series along with additional lengths of tubing 25 depending on the number of sprinklers 19 desired to be connected to the elongated hose 12. The terminal joint 27 comprises an L-shape rather than a T-shape. In this way, the sprinklers 19 are adapted to disperse the fire suppressing material held within the container 20, so as to extinguish a fire within the room. The fire suppressing material stored within the container 20 is under sufficient pressure to allow the material to flow through the elongated hose and be dispersed by the sprinklers 19.

In alternate embodiments of the present invention, the second end 14 of the elongated hose 12 is in fluid communication with a sprinkler bar having one or more sprinklers 19 thereon. The sprinkler bar includes an elongated, rectangular housing that supports and organizes the one or more sprinklers. It is contemplated that the housing of the sprinkler bar is elongated so as to support one or more sprinklers in a linear configuration. The housing may comprises a hollow interior so that the elongated hose 12 and additional lengths of tubing can be disposed therein. Additionally, the housing is adapted to be mounted to a ceiling, wall, or other support structure using any suitable fastener, such as screws, bolts, nails, or adhesives, among others. In this way, the sprinkler bar, and sprinklers thereon are disposed in an elevated position so that fire suppressing material can be dispersed throughout the entirety of a room.

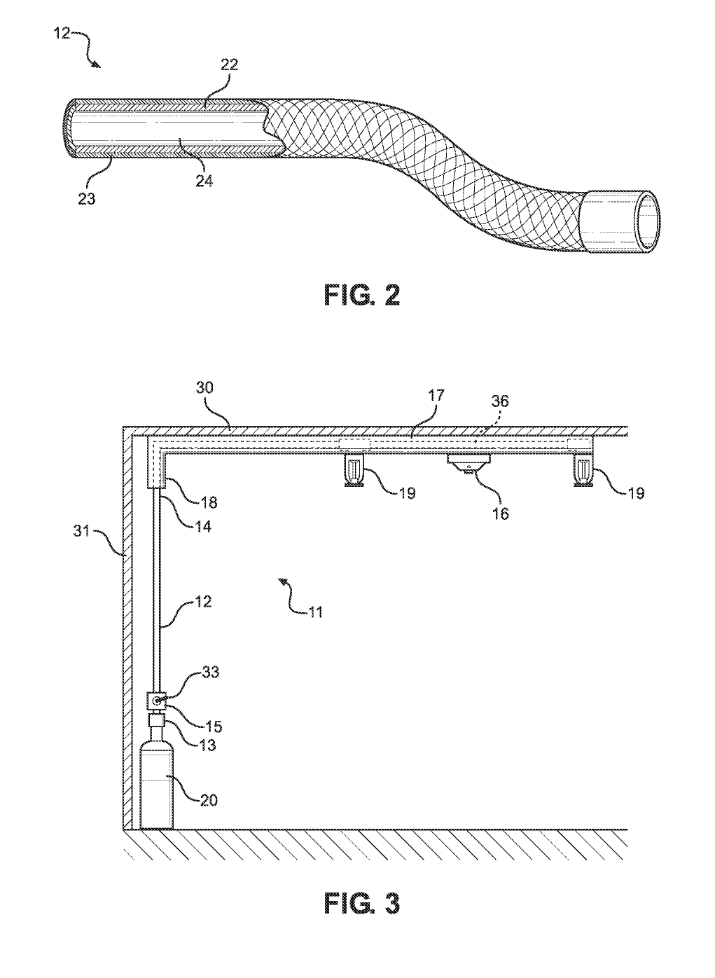

Referring now to FIG. 2, there is shown a cross-sectional view of the elongated hose of the present invention. The elongated hose 12 of the present invention is tubular and is flexible. The hollow interior 24 of the elongated hose 12 allows for fire suppressing material to flow therethrough. The elongated hose 12 is preferably composed of one or more layers of material. In one embodiment, an inner layer 22 is composed of a heat-resistant material that is durable and flexible. An outer layer 23 is composed of a braided metal, such as a steel, to provide increased strength and durability to the elongated hose 12.

Referring now to FIG. 3, there is shown an embodiment of the present invention as installed within a room. The fire suppressing system 11 of the present invention can be installed within a home or building. A container 20 filled with fire suppressing material can be placed on the floor, within a storage cabinet, or in a protective casing. The first end 13 of the elongated hose 12 can be removably secured to the opening of the container 20 and the elongated hose 12 can be positioned so that it extends vertically from the container 20, along the wall 13, and towards a ceiling of a room.

The second end 14 of the elongated hose 12 is connected to a first end 18 of the sprinkler bar 17 of the present invention. The sprinkler bar 17 includes an elongated rectangular housing having a hollow interior and openings thereon through which sprinklers extend. The elongated hose 12 is in fluid communication with tubing within the sprinkler bar that serves to provide fire suppressing material to the sprinklers 19 on the sprinkler bar 17. The sprinklers 19 are positioned on joints disposed within the housing, wherein the joints direct the fire suppressing material to the sprinklers 19 and to additional lengths of tubing 36 used to connect additional sprinklers to the elongated hose 12.

The sprinkler bar 17 is preferably secured to a ceiling in a horizontal orientation. In the illustrated embodiment, the sprinkler bar 17 supports one or more sprinklers 19 in a linear configuration. Preferably, the sprinklers 19 are spaced at a fixed interval so that the sprinklers 19 can evenly dispense a fire suppressing material into a room. Further, the sprinkler bar 17 facilitates installation and eliminates the need to individually secure each sprinkler 19 and the lengths of tubing 36 therebetween.

The sprinkler bar 17 further includes one or more heat sensors 16 or detectors on an exterior surface thereof. The heat sensors 16 can be affixed to the exterior of the sprinkler bar 17 by any suitable fastener such as adhesives, a mounting bracket and screws or bolts, among others. The heat sensors 16 are also preferably spaced at a fixed interval so as to detect an elevated temperature associated with a fire in various portions of a room.

The heat sensors 16 are of conventional construction and may include a heat sensitive element therein. The heat sensors 16 may comprise fixed temperature heat detectors that activate at a predetermined temperature, or rate-of-rise heat detectors that detect a rapid rise in the temperature of a heat sensitive element therein. Thus, the heat sensors 16 are adapted to detect high temperatures that are associated with a fire.

When the heat sensors 16 detect a high temperature related to a fire, the heat sensors 16 are adapted to send a signal to the control valve 15, causing the control valve 15 to open such that fire suppressing material can flow through the elongated hose 12. Once the control valve 15 is open, the fire suppressing material held therein will flow through the elongated hose 12, into the sprinkler bar 17, where it will be dispensed by the sprinklers 19. The heat sensors 16 may communicate with the control valve 15 via a wired or wireless connection therewith. In some embodiments of the present invention the heat sensors 16 comprise wireless transmitters and the control valve comprises a wireless receiver to receive a signal sent from one or more heat sensors 16. In such embodiments, the control valve 15 comprises electromechanical means for opening and closing upon receipt of the signal. Alternatively, the user may manually open or close the valve 15 by actuating the lever 33 thereon.

Thus, the present invention provides an automatic fire suppressing system adapted to detect a high temperature related to a fire by means of one or more heat sensors. The heat sensors then open a valve on a container filled with fire suppressing material, causing the fire suppressing material therein to flow through an elongated hose and into a sprinkler bar, wherein the fire suppressing material is dispersed into a room via one or more sprinklers. The present invention eliminates the need for a user to manually attempt to extinguish a fire, and automatically responds to the increased temperature caused by a fire. This helps to increase the effectiveness of combatting a fire, and reduces the risk of a user becoming injured while trying to extinguish a fire. The present invention can be installed in any home, office, or business lacking a sprinkler system or other automatic fire suppressing system.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fire suppressing system, comprising:
an elongated hose comprising a first end and a second end;
wherein said first end is adapted to be removably secured to one or more containers having a fire suppressing material therein, such that said elongated hose is in fluid communication with said one or more containers;
a control valve disposed on said first end of said elongated hose adapted to control release of said fire suppressing material within said one or more containers;
wherein said second end of said elongated hose is in fluid communication with one or more sprinklers adapted to disperse said fire suppressing material;
one or more heat sensors in communication with said control valve adapted to detect a predetermined temperature associated with a fire.

2) The fire suppressing system of claim 1, wherein said elongated hose comprises an inner layer and an outer layer, wherein said outer layer is composed of a braided metal.

3) The fire suppressing system of claim 1, wherein said first end of said elongated hose comprises threading thereon adapted to engage with a threaded opening of said one or more containers.

4) The fire suppressing system of claim 1, further comprising
a sprinkler bar having an elongated, rectangular housing;
wherein said one or more sprinklers are spaced at a fixed interval on said housing and are connected via a plurality of lengths of tubing.

5) The fire suppressing system of claim 4, wherein said one or more heat sensors are spaced at a fixed interval on an exterior surface of said sprinkler bar.

6) The fire suppressing system of claim 1, further comprising one or more lengths of tubing connecting said one or more sprinklers.

7) The fire suppressing system of claim 1, wherein said one or more heat sensors are adapted to open said control valve when a predetermined temperature has been reached.

8) The fire suppressing system of claim 1, wherein said one or more heat sensors are adapted to wirelessly transmit a signal to said control valve in order to automatically open said control valve.
